(19) United States
(12) Patent Application Publication
(10) Pub. No.: US 2011/0047378 A1
(43) Pub. Date: Feb. 24, 2011

(54) SYSTEM AND METHOD FOR IDENTIFYING ACCOUNT AND PERIPHERAL DEVICE THEREOF

(75) Inventor: Chun-Yi Chen, Taipei County (TW)

Correspondence Address: J C PATENTS, 4 VENTURE, SUITE 250, IRVINE, CA, 92618, US

(73) Assignee: KINPO ELECTRONICS, INC., Taipei County (TW)

(21) Appl. No.: 12/571,700

(22) Filed: Oct. 1, 2009

(30) Foreign Application Priority Data
Aug. 21, 2009 (TW) 98128251

(51) Int. Cl. H04L 9/32

(52) U.S. Cl. 713/168

(57) ABSTRACT

An account identification system, an account identification method, and a peripheral device thereof are provided, wherein the peripheral device has a private key. When a user is about to log into an identification server, besides identifying an account and a password of the user, the identification server further authenticates the peripheral device used by the user so as to identify the user and prevent the user's account from being misappropriated.

### CROSS-REFERENCE TO RELATED APPLICATION

This application claims the priority benefit of Taiwan application serial no. 98128251, filed on Aug. 21, 2009. The entirety of the above-mentioned patent application is hereby incorporated by reference herein and made a part of this specification.

### BACKGROUND OF THE INVENTION

1. Field of the Invention

The present invention generally relates to an account identification system, and more particularly, to an account identification system with a data security function and a peripheral device thereof.

2. Description of Related Art

Information security is one of the major issues in network communication technology. Identifying a user according to an account and a password is the most common identification technique. However, when a user inputs his account and password to log into a system, the account and password may be stolen by a Trojan program. As a result, the user's data may be misappropriated. The Trojan program may be installed and steal the user's account and password without the awareness of the user. This is a very common problem among online games. The virtual property and virtual money possessed by a player of an online game will be stolen if the player's account and password are misappropriated. Thus, a user can only place his important or private documents on the Internet when data security is ensured. However, along with the rapid advancement of computer hardware/software techniques, electromagnetic data managed simply with accounts and passwords is not safe anymore.

The security and privacy of data transmitted or stored on the Internet can be ensured through data encryption/decryption techniques. Regardless of online business, national defense, or online applications, data cryptography is one of the most important issues. In the cryptographic field, cryptographic systems are generally categorized into symmetric cryptographic systems and asymmetric cryptographic systems. The data encryption standard (DES) encryption algorithm is the most popular symmetric cryptographic system, while the RSA encryption algorithm is the most popular asymmetric cryptographic system. A system having the characteristics (for example, a digital envelop function) of both the symmetric and asymmetric cryptographic systems is referred to as a hybrid cryptographic system.

Because electromagnetic data loss always happens, many online game companies develop their own data protection techniques, such as “anti-theft card”, “hardware lock”, and “communication lock”, to prevent such events. An anti-theft card is a card sold together with a game software product. The card has 10˜20 passwords, and each of the passwords is corresponding to a number. A user registers the anti-theft card under his account, and subsequently, the user has to input information on the card whenever the user is about to log in by using his account. However, even though the present technique can protect the user's information to a certain extent, the number on the card is very easy to be cracked as long as the rule for generating the number is understood.

The hardware lock is a more advanced data protection mechanism, wherein a card reader and an IC card are adopted, and when a user is about to log into a system, the user is request to insert his card into the card reader so as to be identified. Even though the present technique is secure and reliable, the installation and utilization of the system are very troublesome and complicated. As a result, users may become reluctant to use this system. The communication lock is presently the commonly-adopted technique. Originally, this technique is implemented through the cooperation between a game company and a telecommunication service provider. The game company sends a password message (the predecessor of communication lock, referred to as a “message security lock”). Through this function, a player can receive from or send messages to a server of the game company, and an unlocking action is performed after the user is identified. However, some issues, such as the proprietary of message fee and the system integration, in the present technique still have to be taken into consideration.

After that, a new generation “communication lock” is provided. Before a user inputs his account information, the user has to input an identification phone number pre-registered and pre-bundled with his account to an unlocking hotline. A server connected to the hotline determines whether the dialed number belongs to this account. If so, the server notifies a login server to unlock the account and allow the user to log in. A mobile communication lock does prevent an account from being stolen. Even if a Trojan program steals the user's password, it cannot make the phone call to unlock the account. However, it is still possible for an intentional person to obtain the user's personal data and deceives the communication lock identification system by changing the phone number so as to obtain the user's account. Besides, the communication lock technique also comes with other problems or inconveniences. For example, the user cannot log into the system if the unlocking hotline is busy or shut down or the identification phone call cannot be made.

### SUMMARY OF THE INVENTION

Accordingly, the present invention is directed to a system and a method for identifying an account, wherein a peripheral device is embedded with a cryptographic algorithm so that the peripheral device achieves a hardware lock function. A user needs not to perform any installation procedure but simply installs and configures the peripheral device to use the hardware lock, which is very convenient. When the user is about to log into a corresponding identification server, the identification server automatically authenticates a private key in the peripheral device to identify the user, so as to prevent the user's account from being misappropriated.

The present invention is directed to an account identification method, wherein dual authentication of a user account is performed by using a peripheral device by embedding a private key in the peripheral device. A user needs not to perform any installation procedure but simply installs and configures the peripheral device to use the hardware lock, which is very convenient. When the user is about to log into a corresponding identification server, the identification server automatically authenticates a private key in the peripheral device to identify the user, so as to prevent the user's account from being misappropriated.

The present invention provides an account identification system including a computer host, a peripheral device, and an identification server. The computer host has a first private key. The peripheral device is connected to the computer host and has a second private key. The identification server has a first public key and a second public key, wherein the first public key is corresponding to the first private key, and the second public key is corresponding to the second private key. The computer host encrypts a login information with the first private key and outputs the encrypted login information to the identification server to log into the identification server. If the login information is correct, the identification server obtains the second public key corresponding to the login information and outputs an authentication message encrypted with the second public key to the peripheral device. The peripheral device outputs an authentication response message encrypted with the second private key to the identification server according to the authentication message. If the authentication response message is correct, the identification server allows the computer host to log into the identification server.

According to an embodiment of the present invention, the login information contains a user account and a password. The identification server decrypts the encrypted login information with the first public key to determine whether the login information is correct. The peripheral device decrypts the authentication message with the second private key. The peripheral device may be a mouse or a keyboard.

According to an embodiment of the present invention, the account identification system adopts an asymmetric cryptographic system. The identification server and the computer host are connected with each other through a network, and the connection between the peripheral device and the login information of a user can be identified through a network registration procedure, so as to start the dual identification function. Besides, the account and password of the user can be sold together with the peripheral device so that when the user logs into the identification server of a specific website or an online game, the identification server automatically authenticates the peripheral device to protect the user's information.

The present invention also provides an account identification method suitable for identifying a login information input by a user. The account identification method includes following steps. A first private key is disposed in a computer host. A second private key is disposed in a peripheral device connected to the computer host. A first public key and a second public key are disposed in an identification server, wherein the first public key is corresponding to the first private key, and the second public key is corresponding to the second private key. The computer host encrypts the login information with the first private key and outputs the encrypted login information to the identification server to log into the identification server. The identification server decrypts the encrypted login information with the first public key to determine whether the login information is correct. If the login information is correct, the identification server obtains the second public key corresponding to the login information and outputs an authentication message encrypted with the second public key to the peripheral device. The peripheral device decrypts the authentication message with the second private key and then outputs an authentication response message encrypted with the second private key to the identification server according to the authentication message. The identification server decrypts the authentication response message with the second public key. If the authentication response message is correct, the identification server allows the user to log into the identification server.

According to an embodiment of the present invention, the step of disposing the first public key and the second public key in the identification server further includes establishing a mapping relationship between the login information of the user, the second public key in the identification server, and the second private key in the peripheral device through a network registration procedure.

The present invention further provides a peripheral device with an account identification function. The peripheral device is connected to a computer host having a first private key. The computer host encrypts a login information with the first private key and outputs the encrypted login information to an identification server to log into the identification server. The identification server decrypts the login information with a first public key. If the login information is correct, the identification server outputs an authentication message encrypted with a second public key to the peripheral device. Notably, the peripheral device decrypts the authentication message with a second private key and outputs an authentication response message encrypted with the second private key to the identification server according to the authentication message. The identification server decrypts the authentication response message with the second public key. If the authentication response message is correct, the identification server allows the computer host to log into the identification server.

The present invention further provides an account identification system including a computer host, a peripheral device, and an identification server. The peripheral device is connected to the computer host and has a private key, and the identification server has a public key. The computer host outputs a login information to the identification server to log into the identification server. If the login information is correct, the identification server outputs an authentication message encrypted with the public key to the peripheral device. The peripheral device outputs an authentication response message encrypted with the private key to the identification server according to the authentication message. If the authentication response message is correct, the identification server allows the computer host to log into the identification server.

As described above, in the present invention, a data security mechanism combining an embedded hardware lock of a computer peripheral device and a cryptographic algorithm is provided, such that a user's information will not be misappropriated even if the account and password of the user are stolen by a Trojan program. In addition, because the hardware lock function is integrated with the peripheral device, the hardware lock function is set up once the peripheral device is installed and configured, so that it is not needed to perform any complicated installation procedure additionally.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates an account identification system according to a first embodiment of the present invention.

FIG. 2 is a flowchart of an account identification method according to a third embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### First Embodiment

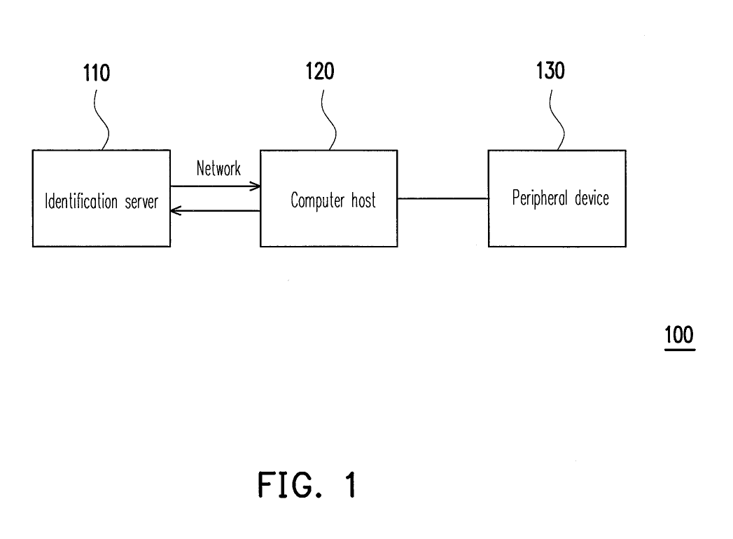

FIG. 1 illustrates an account identification system according to the first embodiment of the present invention. Referring to FIG. 1, the account identification system 100 includes an identification server 110, a computer host 120, and a peripheral device 130. The peripheral device 130 is connected to the computer host 120, and the computer host 120 is connected to the identification server 110 through a network. The peripheral device 130 is a computer peripheral device, such as a keyboard, a mouse, a joystick, a cursor controller, or a flash drive. The identification server 110 may be a server of an online game, an online banking website, or an online business website, etc.

The account identification system 100 has a first public key and a second public key, the computer host 120 has a first private key, and the peripheral device 130 has a second private key, wherein the first public key is corresponding to the first private key, and the second public key is corresponding to the second private key. Information transmitted between the account identification system 100 and the computer host 120 can be encrypted and decrypted by using the public keys and the first private key, which acts as an asymmetric cryptographic system. Because the peripheral device 130 has the second private key, a hardware lock function is achieved by the peripheral device 130 when the peripheral device 130 is installed to the computer host 120. A user needs not to install a hardware lock device or perform any other additional installation procedure.

When the user is about to log into the identification server 110, the computer host 120 transfers a login information (containing an account and a password) input by the user to the identification server 110, wherein the login information is encrypted with the first private key in the computer host 120. The identification server 110 decrypts the login information with the first public key. The identification procedure enters a second phase if the login information is correct. The identification server 110 outputs an authentication message encrypted with the second public key to the peripheral device 130 through the computer host 120. The peripheral device 130 decrypts the authentication message with the second private key and then outputs an authentication response message encrypted with the second private key to the identification server 110 according to the authentication message. The identification server 110 decrypts the authentication response message with the second public key. If the authentication response message is correct, the identification server 110 allows the computer host 120 to log into the identification server 110.

The authentication procedure between the identification server 110 and the peripheral device 130 is automatically carried out by the identification server 110 without any involvement of the user. Because the second private key in the peripheral device 130 is only used for encrypting data but not given out, a Trojan program cannot obtain the second private key when the user logs in. Even if the account and password of the user are stolen by a hacker, the hacker cannot log into the identification server since a peripheral device used by the hacker does not support the authentication procedure in which the second private key is used for encrypting data.

The connection between the peripheral device and the user can be identified and established through a network registration procedure. After the user completes the registration procedure, the identification server generates the corresponding first public key and second public key and places the first private key into the computer host, wherein the second public key is corresponding to the second private key in the peripheral device. Besides, the peripheral device may be sold together with an account. Namely, the peripheral device is directly bundled with a specific account so that when a user logs into the identification server of a specific website (for example, an online game), the identification server automatically authenticates the second private key in the peripheral device to identify the user.

As described above, in the present embodiment, in order to enhance network information security, a second identification procedure is further carried out by using a peripheral device 130 besides procedure for identifying the user's account and password. Because the second private key is stored in the peripheral device 130 instead of the computer host 120, the risk of the second private key being stolen is reduced. Thus, a hacker cannot log into the identification server 110 even if he obtains the user's account and password. In addition, since the peripheral device (for example, a keyboard or a mouse) is essential to the computer, the user needs not to purchase a hardware lock device additionally. The hardware lock function is automatically set up once a driver program of the peripheral device 130 is installed, so that the user needs not to carry out any complicated installation procedure or use any connection port (for example, a USB slot). On the other hand, in the present invention, a more secure account identification method is also provided, wherein an account is bundled together with a peripheral device so that the risk of the account being stolen is reduced and the security of user information is ensured.

### Second Embodiment

In the first embodiment described above, the data transferred between the computer host 120 and the identification server 110 is encrypted and decrypted by using an asymmetric cryptographic system. However, in the present invention, the encryption/decryption procedure between the computer host 120 and the identification server 110 is not compulsory. Referring to FIG. 1, in the second embodiment of the present invention, the computer host 120 may not have the first private key so that only the peripheral device 130 has the second private key. When the identification server 110 determines that the login information is correct, the identification server 110 outputs an authentication message encrypted with a public key corresponding to the second private key to the peripheral device 130. The peripheral device 130 then outputs an authentication response message encrypted with the second private key to the identification server 110 according to the authentication message. If the authentication response message is correct, the identification server allows the user to log into the identification server 110.

Namely, in the present embodiment, the data encryption/decryption method between the computer host and the identification server is not limited, and the account identification is mainly carried out through a peripheral device used by a user. Such a technique also ensures the security of the identification procedure and prevents the user's account from being stolen. The user can still log into the identification server by installing the peripheral device to another computer host.

In the first embodiment and the second embodiment described above, the peripheral device 130 may be a mouse or a keyboard, and the peripheral device 130 has a private key such that an asymmetric cryptographic system can be accomplished between the peripheral device 130 and the identification server 110. Thus, the security of user information is enhanced. The private key in the peripheral device 130 can be stored into a memory of the peripheral device 130, and the authentication response message can be generated by an embedded circuit of the peripheral device 130. The related calculations and information processing can be accomplished through firmware. However, the present embodiment is not limited thereto.

### Third Embodiment

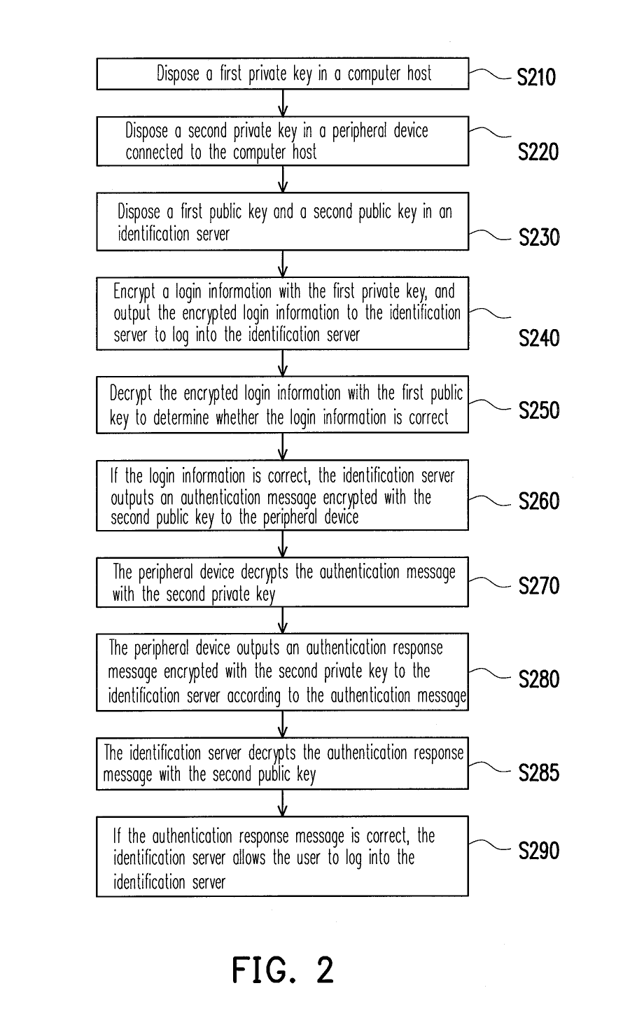

An account identification method can be summarized from the first embodiment described above, wherein the account identification method is suitable for identifying a login information input by a user. FIG. 2 is a flowchart of the account identification method according to the third embodiment of the present invention. Referring to FIG. 2, first, a first private key is disposed in the computer host (step S210). Then, a second private key is disposed in a peripheral device connected to the computer host (step S220). A first public key and a second public key are disposed in an identification server, wherein the first public key is corresponding to the first private key, and the second public key is corresponding to the second private key (step S230). After that, the computer host encrypts the login information with the first private key and outputs the encrypted login information to the identification server to log into the identification server (step S240). The identification server decrypts the encrypted login information with the first public key to determine whether the login information is correct (step S250). If the login information is correct, the identification server obtains the second public key corresponding to the login information and outputs an authentication message encrypted with the second public key to the peripheral device (step S260). The peripheral device decrypts the authentication message with the second private key (step S270).

Thereafter, the peripheral device outputs an authentication response message encrypted with the second private key to the identification server according to the authentication message (step S280). The identification server decrypts the authentication response message with the second public key (step S285). If the authentication response message is correct, the identification server allows the user to log into the identification server (step S290). The other implementation details of the account identification method in the third embodiment of the present invention can be referred to the descriptions of the first and the second embodiment therefore will not be described herein.

As described above, in the present invention, a private key is disposed in a peripheral device such that the peripheral device can carry out account authentication along with an identification server. Accordingly, network security of user data is enhanced. In addition, because the peripheral device is essential to a computer system, the function of a hardware lock can be achieved without performing any additional software installation procedure, which is very convenient to the user. Moreover, because the private key is disposed in the peripheral device and not given out along with the data, a hacker cannot log into the identification server even if he obtains the user's account and password, so that a higher level of data protection is provided. On the other hand, the present invention provides a technique for bundling a user account with a peripheral device such that the security of the user account is ensured and a more secure and convenient account management method is provided to online game players.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An account identification system, comprising:
a computer host, having a first private key;
a peripheral device, connected to the computer host, having a second private key; and
an identification server, having a first public key and a second public key, wherein the first public key is corresponding to the first private key, and the second public key is corresponding to the second private key;
wherein the computer host encrypts a login information with the first private key and outputs the encrypted login information to the identification server to log into the identification server, if the login information is correct, the identification server obtains the second public key corresponding to the login information and outputs an authentication message encrypted with the second public key to the peripheral device, the peripheral device then outputs an authentication response message encrypted with the second private key to the identification server according to the authentication message, and if the authentication response message is correct, the identification server allows the computer host to log into the identification server.

2. The account identification system according to claim 1, wherein the login information comprises an account and a password.

3. The account identification system according to claim 1, wherein the identification server decrypts the encrypted login information with the first public key to determine whether the login information is correct and decrypts the authentication response message with the second public key to determine whether the authentication response message is correct.

4. The account identification system according to claim 1, wherein the peripheral device decrypts the authentication message with the second private key.

5. The account identification system according to claim 1, wherein the peripheral device is a mouse, a keyboard, a cursor controller, a joystick, or a flash drive.

6. The account identification system according to claim 1, wherein the account identification system adopts an asymmetric cryptographic system.

7. The account identification system according to claim 1, wherein the identification server and the computer host are connected with each other through a network.

8. An account identification method, suitable for identifying a login information input by a user, the account identification method comprising:
disposing a first private key in a computer host;
disposing a second private key in a peripheral device connected to the computer host;
disposing a first public key and a second public key in an identification server, wherein the first public key is corresponding to the first private key, and the second public key is corresponding to the second private key;
encrypting the login information with the first private key and outputting the encrypted login information to the identification server to log into the identification server by using the computer host;
decrypting the encrypted login information with the first public key to determine whether the login information is correct by using the identification server;
if the login information is correct, obtaining the second public key corresponding to the login information and outputting an authentication message encrypted with the second public key to the peripheral device by using the identification server;
decrypting the authentication message with the second private key by using the peripheral device;
outputting an authentication response message encrypted with the second private key to the identification server according to the authentication message by using the peripheral device;
decrypting the authentication response message with the second public key by using the identification server; and
if the authentication response message is correct, allowing the user to log into the identification server by using the identification server.

9. The account identification method according to claim 8, wherein the login information comprises a user account and a password.

10. The account identification method according to claim 8, wherein the peripheral device is a mouse or a keyboard.

11. The account identification method according to claim 8, wherein the identification server and the computer host are connected with each other through a network.

12. The account identification method according to claim 8, wherein the step of disposing the first public key and the second public key in the identification server further comprises establishing a mapping relationship between the login information, the second public key in the identification server, and the second private key in the peripheral device through a network registration procedure.

13. A peripheral device with an account identification function, wherein the peripheral device is connected to a computer host having a first private key, the computer host encrypts a login information with the first private key and outputs the encrypted login information to an identification server to log into the identification server, the identification server decrypts the login information with a first public key, if the login information is correct, the identification server outputs an authentication message encrypted with a second public key to the peripheral device, characterized in that the peripheral device decrypts the authentication message with a second private key and outputs an authentication response message encrypted with the second private key to the identification server according to the authentication message, if the authentication response message is correct, the identification server allows the computer host to log into the identification server.

14. The peripheral device according to claim 13, wherein the login information comprises a user account and a password.

15. The peripheral device according to claim 13, wherein the peripheral device is a mouse or a keyboard.

16. An account identification system, comprising:
a computer host;
a peripheral device, connected to the computer host, having a private key; and
an identification server, having a public key;
wherein the computer host outputs a login information to the identification server to log into the identification server, if the login information is correct, the identification server outputs an authentication message encrypted with the public key to the peripheral device, the peripheral device then outputs an authentication response message encrypted with the private key to the identification server according to the authentication message, if the authentication response message is correct, the identification server allows the computer host to log into the identification server.

17. The account identification system according to claim 16, wherein the login information comprises an account and a password.

18. The account identification system according to claim 16, wherein the peripheral device decrypts the authentication message with a second private key.

19. The account identification system according to claim 16, wherein the peripheral device is a mouse, a keyboard, a joystick, a controller, or a flash drive.

20. The account identification system according to claim 16, wherein the account identification system adopts an asymmetric cryptographic system.

21. The account identification system according to claim 16, wherein the identification server and the computer host are connected with each other through a network.
